(19) United States
(12) Patent Application Publication
(10) Pub. No.: US 2009/0217718 A1
(43) Pub. Date: Sep. 3, 2009

(54) Intermodal physical security device

(76) Inventor: James David Porter, Easley, SC (US)

Correspondence Address: J. BENNETT MULLINAX, LLC, P. O. BOX 26029, GREENVILLE, SC, 29616-1029, US

(21) Appl. No.: 12/321,126

(22) Filed: Jan. 15, 2009

Related U.S. Application Data
(60) Provisional application No. 61/011,198, filed on Jan. 15, 2008.

(51) Int. Cl. E05B 43/00

(52) U.S. Cl. 70/271; 292/336.3

(57) ABSTRACT

An apparatus and method for securing a trailer door is provided, the apparatus and process includes a locking apparatus having a housing containing an electronic lock responsive to a signal from a remote wireless device such as a cell phone. A pair of opposingly spaced securement members are used to attach the locking apparatus to vertical support members on the exterior of a cargo door. One of the securement members is responsive to the electronic locking mechanism to engage the support member thereby preventing opening of the trailer door.

### RELATED APPLICATIONS

This application claims the benefit of U.S. Application Ser. No. 61/011,198 filed on Jan. 15, 2008, and which is incorporated herein by reference.

### FIELD OF THE INVENTION

This invention is directed towards a cargo lock for intermodal shipments and tractor trailers. The security device provides for redundant power sources, and is used with both U.S. type truck cargo trailers as well as intermodal ocean cargo trailers. The invention provides a robust locking mechanism which can be opened only through the use of a password transmitted wirelessly through a Bluetooth® communication protocol to the security device. Any Bluetooth® equipped transmitting device such as a telephone or Blackberry® which houses the resident software program that may be used to unlock the security device.

### BACKGROUND OF THE INVENTION

This invention relates generally to types of cargo locks. For instance, U.S. Pat. Nos. 6,536,815; 6,331,022; and 5,857,721 are directed to types of cargo locks. Various types of electronic monitors and sensors are also employed with cargo door locks as taught in U.S. Pat. Nos. 6,092,404 and 7,091,857 as well as U.S. Publications 2004/0055345 and US2004/0108938.

However, there remains room for improvement and variation within the art.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings and photographs.

FIG. 1 shows a perspective view of the security system mounted to a storage container according to the invention;

FIG. 2 is a front elevation view of the security system mounted to the interior side of the storage compartment door;

FIG. 2A shows an upper latch assembly housing;

FIG. 2B shows an alternative embodiment of the security system according to the invention;

FIG. 3 shows a secondary latch assembly mounted on a second storage compartment door;

FIG. 4 shows a cross-section view of the latch assembly carried by a mounting plate affixed to the interior side of the storage compartment door;

FIG. 5 shows an operator for moving the latch assembly and a master lock actuator according to the invention;

FIG. 5A shows the incorporation of a keypad tamper-resistant control for the master lock assembly according to the invention;

FIG. 6 shows an alternative embodiment of the security system;

FIG. 7 a schematic representation of a wireless locking device according to the invention;

FIG. 8 shows an alternative embodiment of the security system according to the invention; and,

FIG. 9 shows an alternative embodiment of the security system with a removable operator incorporating an electronic keypad for operating the master lock assembly.

FIG. 10 is an alternative embodiment of an external locking apparatus designed to interengage vertical bars associated with the rear doors of a tractor trailer and/or intermodal container.

FIGS. 11 and 12 are schematic views showing the respective unlocked and locked engagement of a security device as positioned on external support bars of a transportation container.

FIG. 13 is a view of the embodiment seen in FIGS. 11 and 12 showing the differing engagement of the security device without a support bar of a shipping container.

FIG. 14 illustrates new options and functional features for use with a handheld wireless device which may be used to lock and unlock a security device while also generating information on the container manifest and recording security lock event logs.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

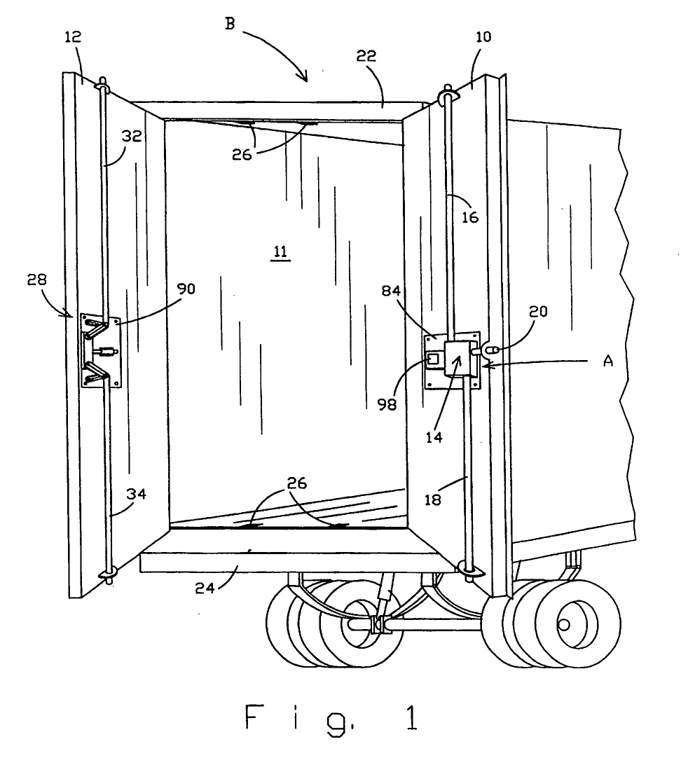

Referring now to the drawings, the invention will be described in more detail. As best shown in FIG. 1, an embodiment of the present invention is an internally mounted security system A or latch assembly used to secure an entryway for a storage compartment B. Typically the storage compartment is a storage container of the type often found at a construction site or used by semi-tractor trailers. Generally, these storage compartments have two large doors 10 and 12 which are located at one end of the compartment to gain access to the compartment interior 11. The components of the security system used to secure the doors are advantageously mounted on the interior sides of the doors within the storage compartment interior in order to eliminate tampering with the locking components and prevent unauthorized access to the contents of the storage compartment.

Referring to FIG. 1, the security system includes a primary latch assembly 14 carried on the interior side of first door 10 for latching the door in a closed position to prevent access to the storage compartment interior. Because the latch assembly is disposed entirely within the compartment interior when door 10 is locked in a closed position, there is nothing on the outside of the storage compartment that may be tampered with to attempt to gain access the compartment interior. Primary latch assembly 14 has an engaged position for latching movable door 10 in a closed position in which the entryway for the compartment interior is closed off, and a disengaged position wherein door 10 may be opened to provide access to the compartment interior.

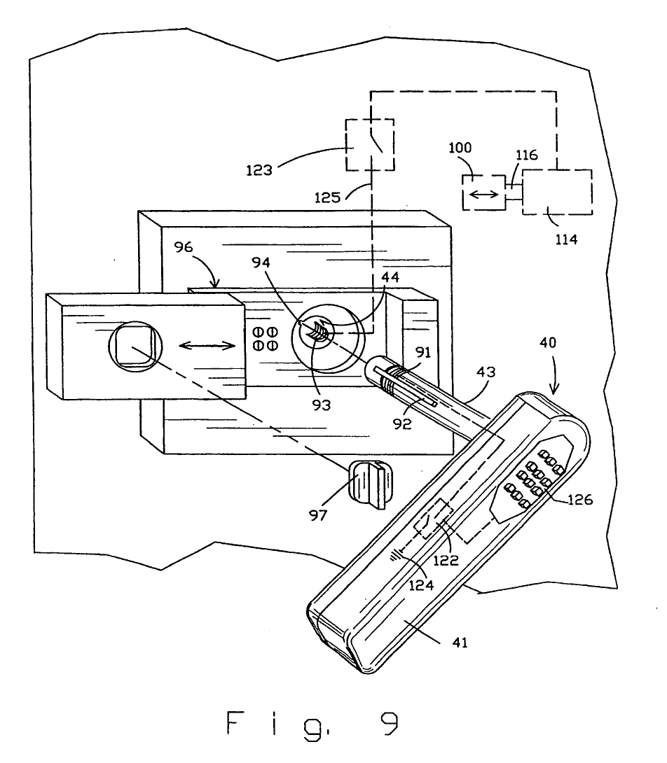

In order to latch door 10 to the storage compartment, primary latch assembly 14 includes reciprocating latch elements 16, 18, and 20. Latch elements 16 and 18 are vertical reciprocating latch elements aligned to engage top side 22 and bottom side 24 of storage compartment B when latch assembly 14 is in the engaged position. Top and bottom sides 22 and 24 include receiving members 26 for receiving latch elements 16 and 18 to latch door 10 in the closed position. In the preferred embodiment, the latch elements are formed from hardened metal rods resistant to bending or breaking from tampering. As shown in FIG. 8, adjustable connectors 162 are included in the rods to increase or decrease the effective length of the latch elements to vary the portion of the latch element that is received by the receiving members. The receiving members can be formed from holes, with or without reinforcement, cut into top and bottom sides 22 and 24, having a sufficient diameter to receive latch elements 16 and 18. In the preferred embodiment, receiving members 26 are made from hardened metal sleeves flush mounted into top and bottom sides 22 and 24 of the interior surface of the storage compartment, as best shown in FIG. 1. Latch element 20 is a horizontal reciprocating latch element aligned to engage the side of the storage compartment where only one door is provided to access the storage compartment. An additional receiving member can be mounted on the side of the storage compartment in order to receive latch element 20 and secure door 10.

As shown in FIG. 1, when two doors are provided which create an entryway into the compartment interior, horizontal reciprocating latch element 20 can be used to secure second door 12 in a closed and locked position. Second door 12 carries a secondary latch assembly 28 on the interior side of door 12 for latching the door in a closed position to prevent access to the storage compartment interior. When doors 10 and 12 are moved to the closed position and primary latch assembly 14 is moved to the engaged position, latch element 20 is moved horizontally to engage a securing bracket 30 and operate secondary latch assembly 28 as described herein below in more detail. In the preferred embodiment, secondary latch assembly 28 includes secondary reciprocating latch elements 32 and 34 vertically aligned to engage receiving members 26 and latch second door 12 in the closed and locked position together with first door 10 and storage compartment B.

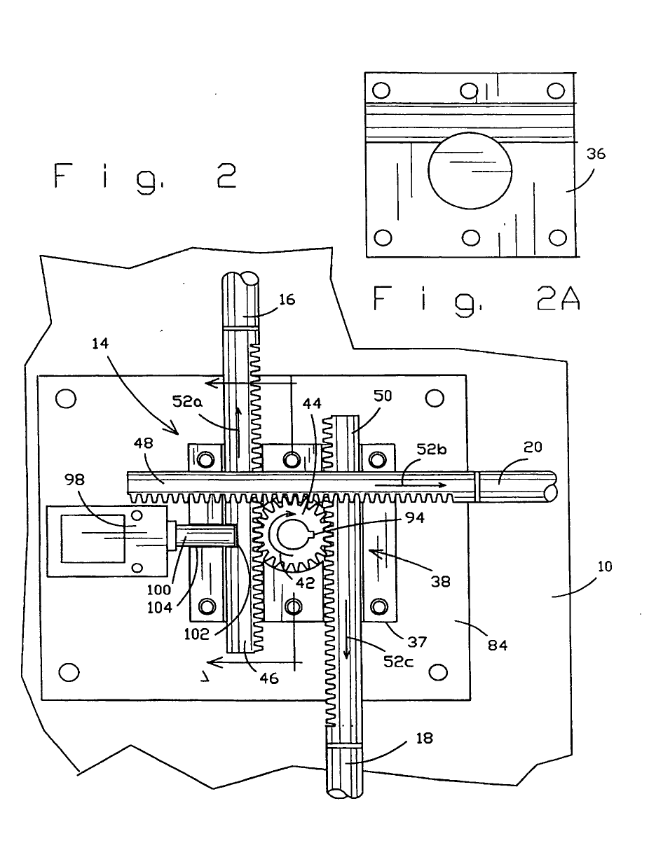

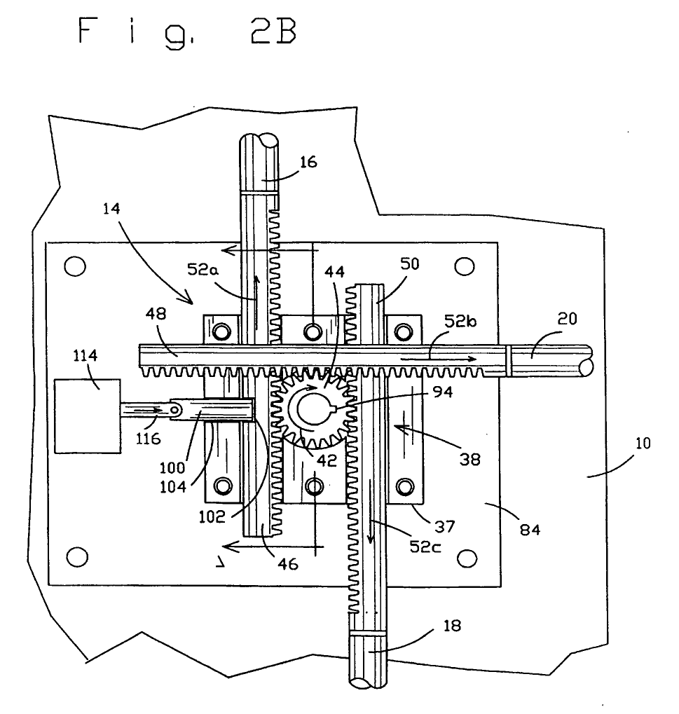

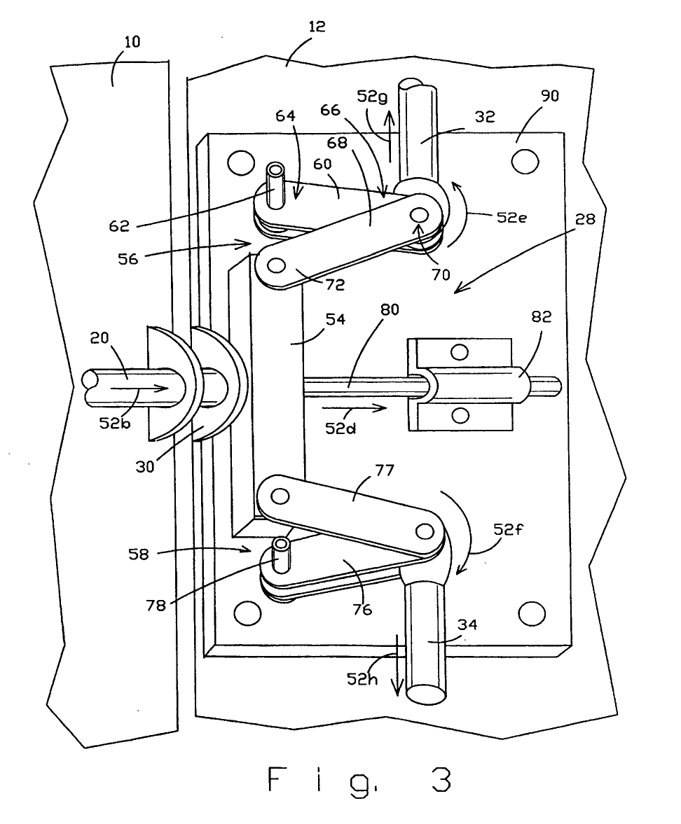

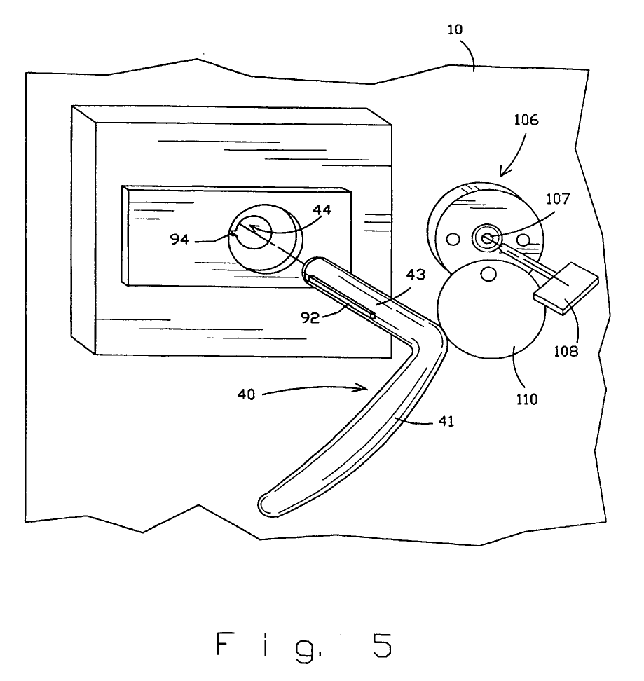

Referring now to FIG. 2, latch assembly 14 is shown with an upper housing 36 (FIG. 2a) removed from lower housing 37 to expose the internal latch assembly components. Bolts 39 (FIG. 4) are used to secure upper housing 36 to lower housing 37. Latch assembly 14 includes a latch actuator, designated generally as 38, connected to latch elements 16, 18, and 20. Latch actuator 38 is operated by an operator 40 (FIG. 4) to move the latch assembly between engaged and disengaged positions, as described further below. In the preferred embodiment, latch actuator 38 is formed using a rack and pinion mechanism where pinion 44 receives operator 40 and is rotated in direction 42. Toothed pinion 44 meshes with toothed racks 46, 48, and 50 to complete the conversion of rotary movement of the pinion to linear movement of the racks and latch elements to position the latch assembly in the engaged or disengaged position. As pinion 44 is rotated in direction 42 to move primary latch assembly 14 to the engaged position, racks 46, 48 and 50 are extended in direction 52a, 52b and 52c simultaneously to force latch elements 16 and 18 into receiving members 26 carried in the top and bottom sides 22 and 24 of storage compartment B. In the preferred embodiment, latch element 20 is forced in direction 52b to engage securing bracket 30 and operate secondary latch assembly 28 to secure second door 12 in the closed and locked position.

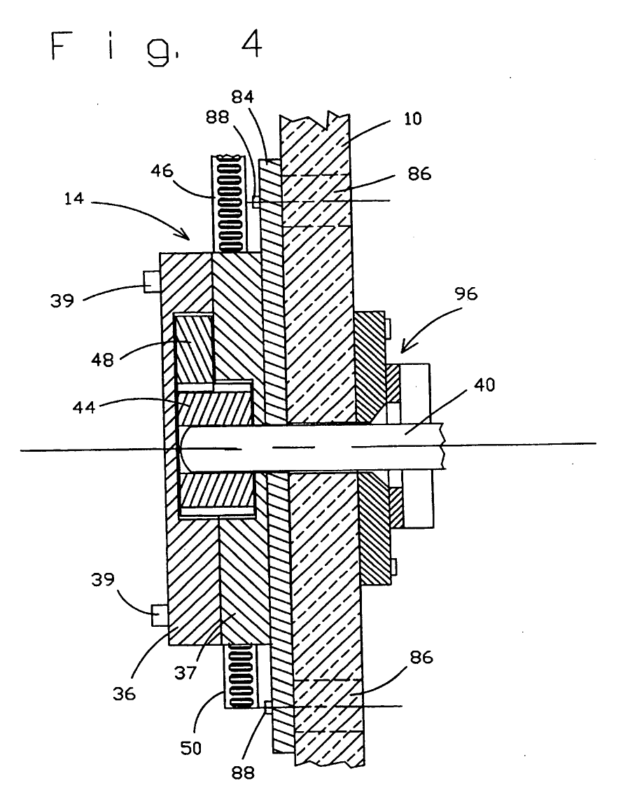

Referring to FIG. 3, secondary latch assembly 28 is carried on the interior compartment side of door 12 and includes abutment bar 54 which is engaged by horizontal reciprocating latch element 20. Abutment bar 54 is pivotally attached to an upper pivot arm, designated generally as 56, and a lower pivot arm, designated generally as 58. Pivot arm 56 includes a first arm segment 60 pivotally connected to a mounting bolt 62 at a first end 64, and a second end 66 pivotally connected to latch element 32. A second arm segment 68 has a first end 70 pivotally connected to latch element 32 and a second end 72 connected to abutment bar 54. Lower pivot arm 58 is of the same configuration, only inverted so that first arm segment 76 is pivotally connected to mounting bolt 78 and latch element 34 with second arm segment 77 connecting latch element 34 to abutment bar 54. As latch element 20 is moved in direction 52b, abutment bar 54 is engaged and moved in direction 52d, which forces upper pivot arm 56 to extend in direction 52e and lower pivot arm 58 to extend in direction 52f. As the pivot arms extend, latch element 32 is moved in direction 52g to engage receiving member 26 on top side 22 of storage compartment B, while latch element 34 is moved in direction 52h to engage receiving member 26 on bottom side 24 of storage compartment B. Because abutment bar 54 is pivotally connected on both ends, a guide member 80 is carried by abutment bar 54 to keep the plate in a fixed vertical position. Guide member 80 is received by guide bracket 82 which maintains abutment bar 54 in proper vertical alignment with horizontal latch element 20.

Referring to FIG. 4, a cross section of latch assembly 14 is shown carried on the interior side of door 10 by a mounting plate 84. Because many doors on storage containers do not have flat surfaces where the latch assembly can be mounted, a mounting plate 84 can be anchored to the door to provide a flat surface for the latch assembly to be carried on the door. As well, the mounting plate provides a solid reinforcing plate that would have to first be defeated before the latch assembly components could be tampered with. In the preferred embodiment, door anchors 86 are inserted into door 10 which provide a reinforced structure to attach mounting plate 84 to the door. Bolts 88 are inserted through mounting plate 84 and into door anchor 86. As the bolts are tightened into door anchors 86, mounting plate 84 is secured against door 10 and provides a solid reinforcing structure to the door, which increases the tamper-resistance of the latch assembly and storage compartment door. Referring to FIGS. 1 and 3, a mounting plate 90 is also used to carry secondary latch assembly 28 on the interior side of door 12. Plate 90 is also mounted to door 12 as described above using door anchors 86.

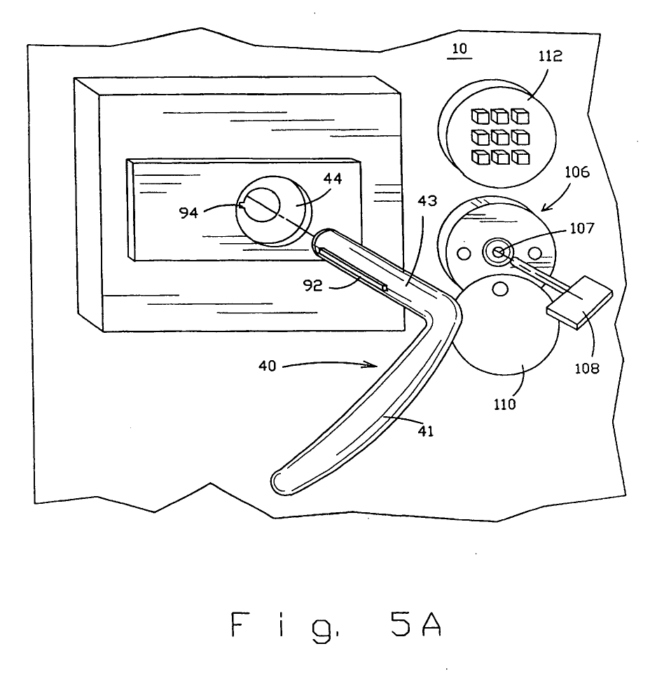

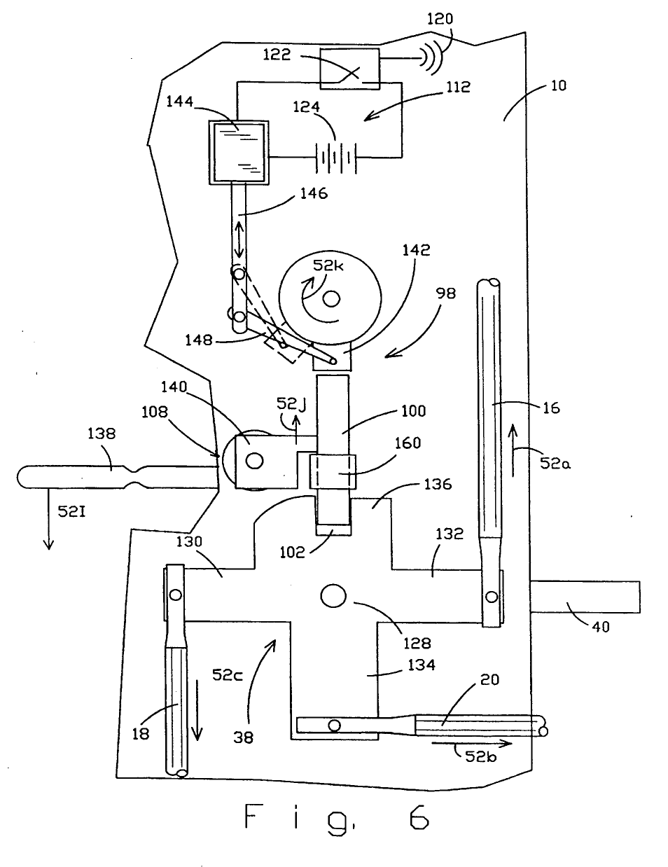

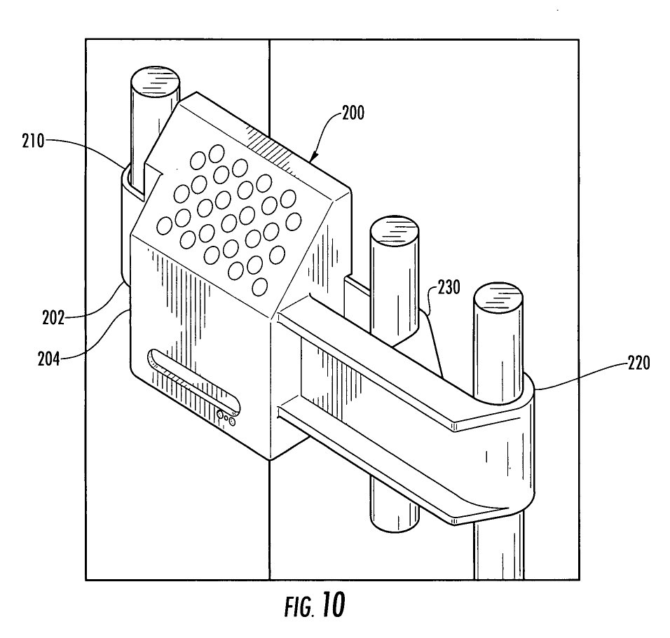

Referring to FIG. 5, in the preferred embodiment, operator, designated generally as 40, is shown having a handle 41 attached to a shaft 43 which can be manually operated to engage and disengage latch assembly 14. Handle 41 is also removable in order to eliminate any security system components on the exterior of door 10. To engage with pinion 44 (FIG. 4), handle shaft 43 is provided with a key 92 that is received in keyway 94 of pinion 44. This allows handle 41 to rotate pinion 44 and operate latch assembly 14. Referring to FIG. 4, because operator 40 must be inserted through door 10 to rotate pinion 44, when operator 40 is removed, a hole is created which can be used to tamper with latch assembly 14. By simply providing a magnetic key locking cover 96 with a magnetic key 97 (as shown in FIG. 9) mounted to the exterior side of door 10, the hole can be covered and the latch assembly can not be tampered with.

As can best be seen in FIG. 2, a master lock assembly 98 is operatively connected to latch assembly 14 for controlling whether latch actuator 38, and ultimately latch assembly 14, can be operated between engaged and disengaged positions. Master lock 98 is carried by mounting plate 84 on the interior compartment side of door 10. Master lock 98 includes a first locking part 100 that interlocks with a second locking part 102 carried by latch actuator 38. Master lock 98 has a locked position wherein first locking part 100 is locked together with second locking part 102 to prevent latch actuator 38 from moving latch assembly 14 to the disengaged position. Master lock 98 also has an unlocked position wherein first locking part 100 and second locking part 102 are unlocked to allow latch actuator 38 to move latch elements 16, 18, and 20 to the disengaged position which allows doors 10 and 12 to open. In the preferred embodiment, first locking part 100 is a hardened metal deadbolt which can be inserted through opening 104 in lower housing 37 of latch assembly 14. The deadbolt can be replaced by any member which prevents the latch assembly from moving between engaged and disengaged positions, such as a pin that would be inserted into one of the latch elements. Preferably, the deadbolt interlocks with second locking part 102. As illustrated in FIG. 2, second locking part 102 is a notch formed in rack 46 which receives first locking part 100. The notch must be of a sufficient size and depth to receive first locking part 100 and prevent rack 46 from moving. Second locking part 102 may comprise a number of various members, such as a bracket, that can be carried by the latch actuator or other components of the latch assembly that can interlock with first locking part 100 and prevent the latch assembly from operating. In the preferred embodiment, master lock assembly 98 is a mechanical lock capable of retracting first locking part 100 from second locking part 102. Mechanical locks are well-known in the art, and only a description necessary to the understanding of the present invention is disclosed herein. A suitable mechanical lock is disclosed in U.S. Pat. No. 4,142,388.

Referring to FIG. 5, master lock assembly 98 (FIG. 2) is operatively associated with a master lock actuator 108 operable from outside the storage compartment through door 10 for moving first locking part 100 to the unlocked position. When latch assembly 14 is in the engaged position with door 10 closed and master lock assembly positioned to the locked position, access to the storage compartment interior is prevented. The master lock actuator must be operated in order to unlock the master lock assembly and allow latch assembly 14 to be moved to the disengaged position so that the door may be opened. In the preferred embodiment, master lock actuator 108 comprises a key which is inserted through a keyhole 107 in door 10 and is received by master lock assembly 98. Turning master lock actuator 108 unlocks master lock assembly 98 by retracting first locking part 100, as disclosed in U.S. Pat. No. 4,412,388. A keyhole cover, designated generally as 106, is provided to prevent tampering with the keyhole that could lead to tampering with master lock assembly 98. As shown in FIG. 5, keyhole cover 106 includes a rotating lid 110 that is used to prevent any tampering with the keyhole itself or the internally mounted security system components. Lid 110 may be locked in a closed position covering keyhole 107 by any number of well known locking means. In an alternative embodiment shown in FIG. 5a, a tamper-resistant master lock control 112 is provided for controlling operation of master lock assembly 98 between locked and unlocked positions from outside said compartment. The tamper-resistant master lock control has an activated condition wherein the master lock actuator may be operated to unlock the master lock assembly. In the preferred embodiment, tamper-resistant master lock control 112 comprises a combination keypad lock 112 which sets the tamper-resistant master lock control in the activated condition when the correct combination is entered on the combination keypad. Thus, entering the correct code on combination keypad 112 allows master lock assembly 98 to be operated by master lock actuator 108 so that first locking part 100 is retracted from second locking part 102 to allow latch assembly 14 to be moved to the disengaged position.

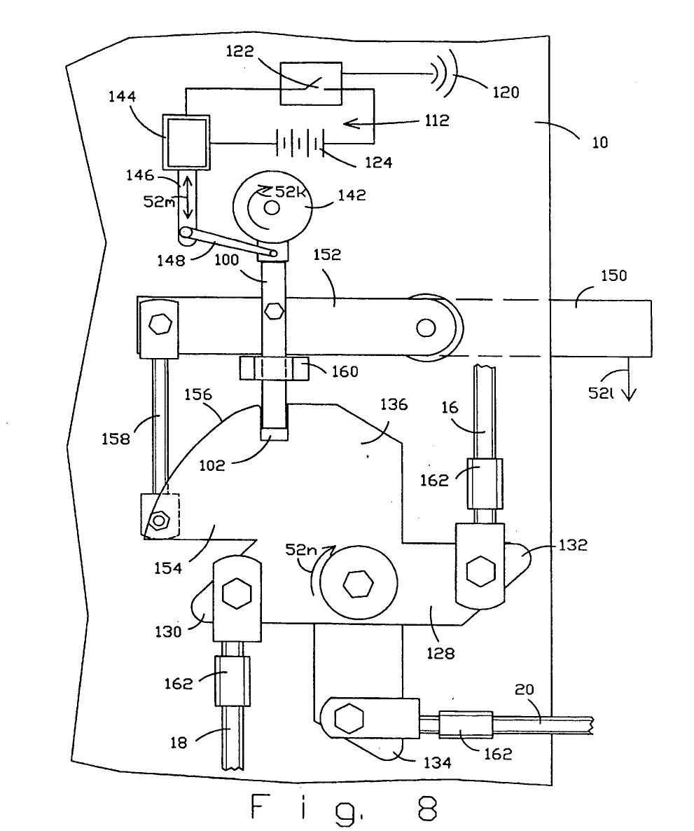

Referring to FIG. 2B, an alternative embodiment is provided wherein master lock assembly 98 includes a solenoid 114 mounted on the interior side of door 10. Solenoid 114 includes a solenoid arm 116 connected to first locking part 100. Solenoid arm 116 is extended and retracted by the solenoid to moved first locking part 100 between locked and unlocked positions with second locking part 102, respectively. Tamper-resistant master lock control 112 is operatively associated with solenoid 114 and has an activated condition wherein the solenoid arm is retracted to move first locking part 100 to the unlocked position, allowing the latch assembly to be disengaged and door to be opened. In this embodiment, tamper-resistant master lock control 112 is an electronic remote control 118 operated from outside the storage compartment. Remote control 118 sets the activated condition of tamper-resistant master lock control 112 for activating solenoid 114 so that solenoid arm 116 moves first locking part 100 to the retracted unlocked position. Referring to FIG. 7, remote control 118 transmits a signal to an antenna 120 which sends that signal to a solenoid control 122. Solenoid control 122 may be a simple switch which completes a circuit or a microprocessor requiring a particular signal or code in order to activate the solenoid and set the activated condition from the remote control. The solenoid control then allows power from power supply 124 to flow to solenoid 114 and retract solenoid arm 116. When the signal stops, solenoid control 122 shuts off power to the solenoid, which then extends solenoid arm 116, by way of gravity, spring or other well known means, to interlock first locking part 100 with second locking part 102.

As shown in FIG. 9, a particularly advantageous embodiment of tamper-resistant master lock control 112 is provided. In FIG. 9, the tamper-resistant master lock control is incorporated into handle 41 of operator 40. The tamper-resistant master lock control includes a keypad 126 operatively associated with solenoid control 122 for controlling activation of solenoid 114 (FIG. 7). As described above, master lock assembly 98 includes a solenoid with a solenoid arm 116 that is extended and retracted by the solenoid to move first locking part 100 between locked and unlocked positions with second locking part 102, respectively. Solenoid control 122, incorporated into handle 41, includes a microprocessor in electronic communication with electronic keypad 126. The microprocessor receives an activation code from electronic keypad 126 to provide the activated condition for the tamper-resistant master lock control. Thus, when the correct code is entered on electronic keypad 126, the microprocessor sends code and power from power supply 124, incorporated into handle 41, along pathway 125. A second solenoid control 123 is proved within the compartment interior for receiving the code and power. If the corrected code is received by second solenoid control 123, power is then sent to solenoid 114 to retract first locking part 100. In order to transfer power and code from operator 40 to second solenoid control 123 and solenoid 114, shaft 43 includes a first contact 91 for providing electronic communication with a second contact 93 carried within the compartment interior by latch assembly 14. When shaft 43 is inserted into pinion 44, first contact 91 is aligned with second contact 93 to provide a transfer point for both power and code from solenoid control 122 to second solenoid control 123. If the entered code corresponds to an unlock command retained by second solenoid control 123, power from power supply 124 is sent to solenoid 114 to retract first locking part 100 to allow operator 40 to rotate pinion 44 and disengage latch assembly 14.

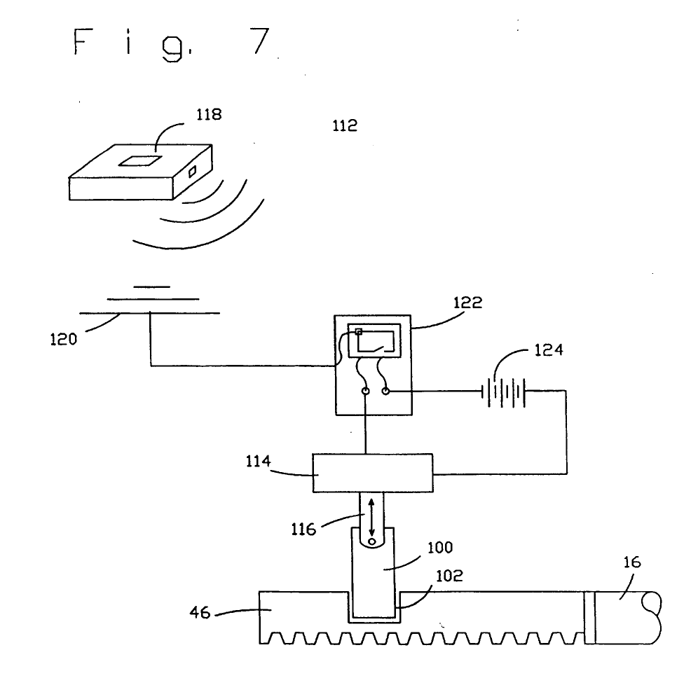

Referring now to FIG. 6, an alternative embodiment for the security system is shown. Latch actuator, designated generally as 38, includes a rotary hub 128 carried by the interior side of door 10. Operator 40 is connectable to the rotary hub from outside the storage compartment and is rotatable to rotate the hub inside the compartment. Rotary hub 128 includes a plurality of latch arms 130, 132 and 134 connecting to the latch elements. Latch elements 16, 18 and 20 are pivotally connected to the latch arms so that when the hub is rotated to move the latch assembly to the engaged position, latch element 16 extends in direction 52a, latch element 18 extends in direction 52c and latch element 20 extends in direction 52b to latch with the storage compartment or engaged secondary latch assembly as described previously above. An additional latch arm 136 includes second locking part 102 for interlocking with first locking part 100 to prevent rotary hub 128 from rotating. Master lock actuator, designated generally as 108, includes a handle 138 operable from outside the storage compartment through door 10 for moving first locking part 100. Handle 138 is connected to lifting bar 140 so that when handle 138 is moved in direction 52i, lifting bar 140 is moved in direction 52j along with first locking part 100. However, master lock assembly, designated generally as 98, includes a stop 142 which must be moved before master lock actuator 108 may be operated. Stop 142 is pivotally attached to the interior side of door 10 above first locking part 100 to prevent movement of the first locking part to the unlocked position. Master lock assembly 98 further includes a solenoid 144 operatively associated with stop 142. The solenoid includes a solenoid arm 146 and a connector linkage 148 connecting the solenoid arm to stop 142. Solenoid arm 146 is retracted by solenoid 144, as described above, to move stop 142 in direction 52k to allow movement of first locking part 100 in direction 52j. A tamper-resistant master lock control, designated generally as 112, is operatively associated with solenoid 144 and includes an activated condition wherein solenoid arm 146 is retracted. In the preferred embodiment of the security system shown in FIG. 6, tamper-resistant master lock control 112 includes an electronic remote control operable from outside the storage compartment and sets the activated condition for activating solenoid 144 as described in detail above. In a further advantageous embodiment of the security system shown in FIG. 6, tamper-resistant master lock control 112 includes a combination lock operated from outside the storage compartment which is directly connected to stop 142. Entering the correct combination sets the activated condition which allows the combination lock to rotate and move stop 142 in direction 52k to allow movement of first locking part 100. The combination lock can also be unlocked through use of a key or other well known means for operating locks.

Referring now to FIG. 8, an alternative embodiment for the security system is shown. In this embodiment, master lock actuator 98 and operator 40 have been combined to provide a single handle for moving first locking part 100 and rotating latch actuator 128. As shown in FIG. 8, a latch actuator is provided in the form of a rotary hub 128 pivotally connected to the interior of door 10 with latch arms 130, 132 and 134 connected to latch elements 16, 18 and 20. Handle 150 on the outside of the storage compartment is connected through door 10 to bar 152 for rotating rotary hub 128 and lifting first locking part 100. Latch arm 136 includes an extended portion 154 with a rounded outer edge 156. The extended portion of latch arm 136 is connected to bar 152 by linkage 158, which is pivotally attached to both bar 152 and extend portion 154 of latch arm 136. Extended portion 154 further includes second locking part 102 for receiving first locking part 100 as described in detail above. When handle 150 is moved in direction 521, bar 152 is moved in direction 52m which first raises first locking part 100 in direction 52m before rotating hub 128. Bracket 160 is provided which helps maintain first locking part in proper vertical alignment with second locking part 102. As rotary hub 128 is moved in direction 52n, rounded outer portion 156 of extended portion 154 of latch arm 136 allows first locking part 100 to ride along the edge as the hub is rotated. When the hub is moved back to the engaged position opposite direction 52n, first locking part 100 will drop into second locking part 102 and prevent the hub from rotating. As was described in detail above, a stop 142 is provided for preventing first locking part 100 from being moved. The stop is connected to a solenoid 114 operated associated with a tamper-resistant master lock control of the type disclosed above.

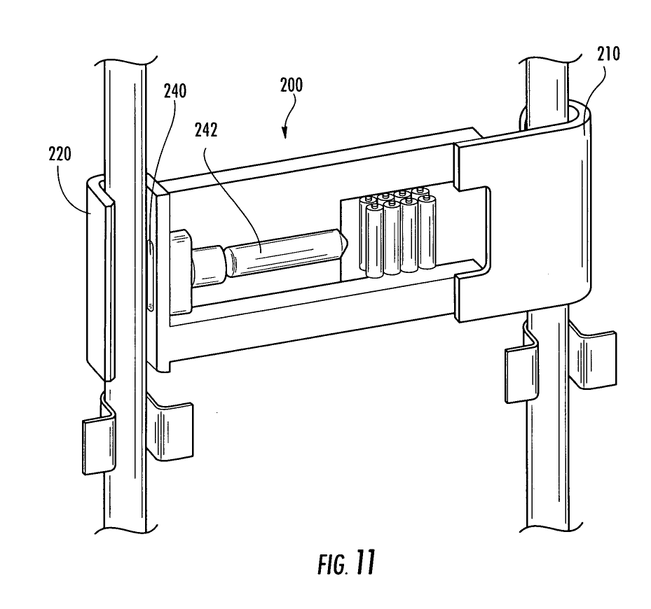

As seen in reference to FIG. 10 is an alternative embodiment of a security device which may b positioned externally. Security device 200 defines a first securement member 210 which is adapated for engaging a bar on the external of tractor trailer or intermodal container. A second securement member 220 is positioned on the opposite end of security device 200. As seen, the second securement member 220 is adapted for the engagement of at least one of a bar location of an intermodal container or alternatively engaging a tractor trailer bar location. While the illustrated embodiment illustrates a third securement member 230, such a configuration is optional and is not preferred unless all three bars exist on a container to be secured. As further seen in FIG. 10, a top surface 202 of the security device 200 defines a tapered face that facilitates water runoff. A plurality of clear lenses 204 are designed to allow for the transmission of light so that a solar panel (not illustrated) can be used to power the internal electronics of a locking mechanism including keeping charged a rechargeable battery.

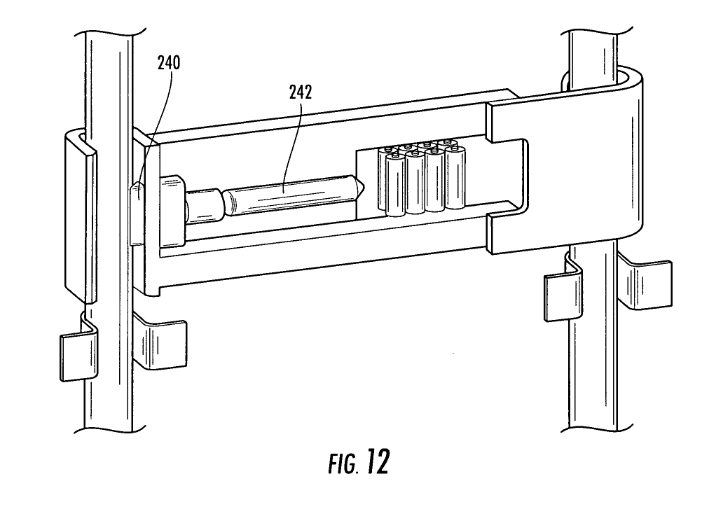

Set forth in FIGS. 11 and 12 are schematic views of an alternative locking device showing the unlocked FIG. 11 and locked FIG. 12 positions of the security apparatus. As seen in FIG. 12, a solenoid 242 may be used to engage a latch 240 which as seen in FIG. 12 provides a locking force around the container bar. Since the opposing bar is secured by respective securement members 220 and 210 on opposite sides of the central door seam, when the security device 200 is engaged, the doors of the container cannot be opened. For purposes of illustration, FIGS. 11 and 12 illustrate a rear view of the device 200. The back housing member which encloses and helps secure the electronics and locking member are not illustrated.

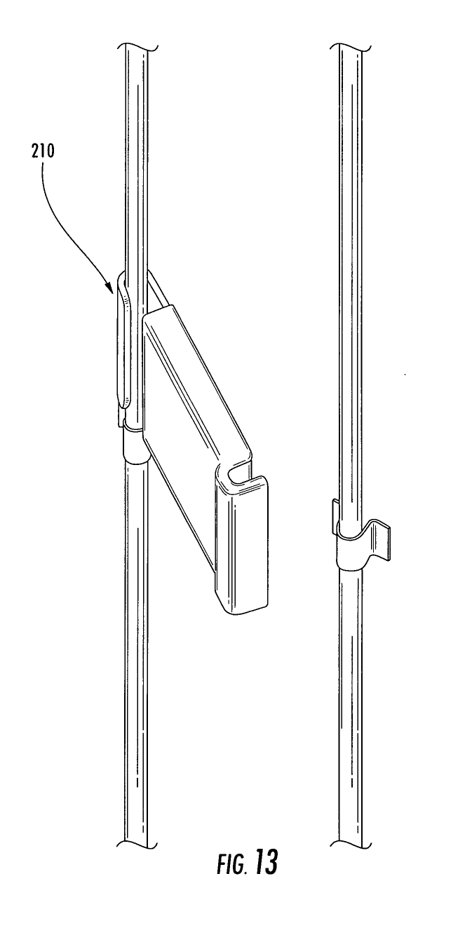

As seen in reference to FIG. 13, the security device 200 is shown in an unlocked state and is able to swivel about the container bar associated with securement member 210. This allows the security device 200 to be pivoted out of the way so that the doors may be opened and then pivoted back into place such that securement member 220 will come into contact with the associated container bar such that the security device when actuated secures the respective bars together, thereby preventing opening of the container doors.

It is understood and appreciated that the electronic locking mechanisms of the various embodiments may take a variety of forms. There are a number of electronic locks and solenoid controlled locking mechanisms that may be utilized to provide the internal locking mechanism for the illustrated embodiments of both the interior cargo security systems as well as the external security device.

For the various embodiments set forth herein using an electronic locking and unlocking mechanism, another aspect of the present invention is to provide a wireless receiver in communication with the solenoid or other electronic locking mechanisms such that the engagement and disengagement of a lock can be controlled by an external signal. Preferably, the receivers associated with the locking apparatus are responsive to a signal transmitted via a Bluetooth® device which must transmit a predetermined PIN number in order to unlock the device. The nature of Bluetooth® technology is such that the Bluetooth® device does not have to be in an active service area in order to transmit the proper signal. Alternatively, the receiver can be receptive to a unique tone from a touch tone phone.

Using Bluetooth® and other radio control enabled devices allow for a wide variety of varying levels of security to be adopted for the security device. In the simplest embodiment, the Bluetooth® receiver can be “open” such that any Bluetooth® transmitter which transmits a proper coded sequence will activate the locking mechanism. However, whenever increased security is desired, software associated with the receiver and circuit boards comprising the electronics of the locking mechanism can be configured so that only authenticated wireless devices may be able to transmit the proper codes. In other words, a non-authenticated cell phone, even if transmitting the proper code sequence, will not be recognized.

Additionally, the locking mechanism can be in communication with one or more GPS location devices such that the proper Bluetooth® code will only be accepted by the security device within a defined geographic region (geofencing). This provides additional protection such that even individuals having access to the code are unable to access the container contents until the container is physically present within a defined geographic location.

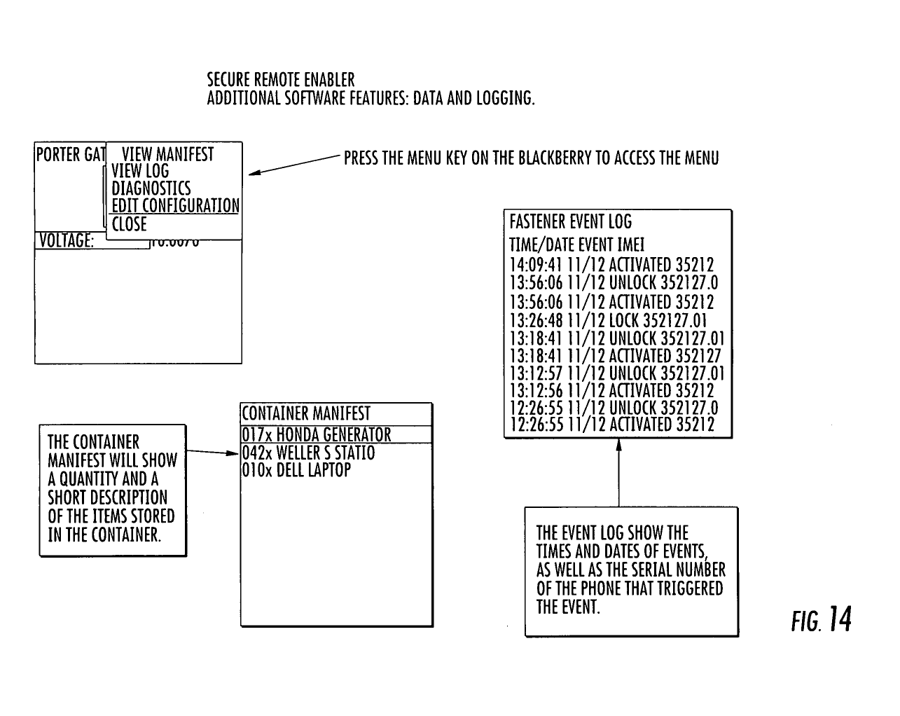

As part of the communication protocol between the wireless device and the security device, appropriate software, operating systems, and hardware can be present in both the authorized wireless device and the security device such that the security device and/or wireless device maintains a log of locking and unlocking events, including capturing identifying information of the wireless device used. The monitoring software can also be integrated with inventory management tools such as using RFID technology to monitor and track inventory. The wireless device can be used to generate inventory and manifests at each point when the container is accessed. One such example of an inventory manifest can be seen in reference to FIG. 14.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention. In addition, it should be understood that aspects of the various embodiments may be interchanged, both in whole, or in part. Therefore, the spirit and scope of the invention should not be limited to the description of the preferred versions contained therein.

1. A locking apparatus for a trailer door comprising:
a housing containing an electronic locking mechanism, said locking mechanism responsive to a transmitter generating an encoded signal generated from a remote wireless device;
a first securement member attached to said housing, said first securement member adapted for engaging a first vertical support member of a trailer door;
a second securement member attached to said housing, said second securement member adapted for engagement of a second vertical support member of a trailer door; and,
at least of one said first and said second securement members being responsive to said electronic locking mechanism, thereby securing the locking apparatus between the first vertical support member and said second vertical support member.

2. The locking apparatus according to claim 1 wherein said first securement member and said second securement member each define an arcuate terminus adapted for engaging a cylindrical support member associated with a trailer door.

3. The locking apparatus according to claim 1 wherein at least one of said first and said second securement members is slidably movable relative to said housing.

4. The locking apparatus according to claim 1 wherein at least one of said first and second securement members is in communication with a retractable locking member which, when engaged, secures the respective securement member to a respective vertical support member.

5. A process of securing a cargo trailer door comprising the steps of:
providing an electronic locking mechanism on either an interior or an exterior of a cargo container, said electronic locking mechanism responsive to a remotely transmitted encoded signal;
activating said electronic locking mechanism through a handheld wireless device, said handheld wireless device used to generate an unlock code recognized by said electronic locking mechanism; and,
generating a log of a each unlock command, received by said electronic locking mechanism, said log including a unique identification of the wireless device used to transmit the unlock coded signal.

6. The process of securing a cargo trailer door according to claim 5 comprising the additional step of generating a manifest of cargo contents upon entry of a valid unlock code.

7. The process of securing a cargo trailer door according to claim 6 comprising the additional step of displaying on said handheld wireless device said manifest.
